(19) United States
(12) Patent Application Publication
(10) Pub. No.: US 2019/0332166 A1
(43) Pub. Date: Oct. 31, 2019

(54) PROGRESSIVE POWER-UP SCHEME FOR CACHES BASED ON OCCUPANCY STATE

(71) Applicant: QUALCOMM Incorporated, San Diego, CA (US)

(72) Inventors: Siddesh HALAVARTHI MATH REVANA, Bangalore (IN); Kaustav ROYCHOWDHURY, Bangalore (IN)

(21) Appl. No.: 15/964,069

(22) Filed: Apr. 27, 2018

(51) Int. Cl. G06F 1/32; G06F 12/1045; G06F 1/28

(52) U.S. Cl. CPC G06F 1/3296; G06F 12/1045; G06F 2212/657; G06F 2212/6032; G06F 1/28

(57) ABSTRACT

A system is disclosed. The system comprises a set-associative memory cache comprising a plurality of ways, a plurality of way power controllers (WPCs), each WPC being respectively associated with a respective way of the plurality of ways, and a cache controller. The cache controller is configured to provide a way activation signal to each of the plurality of WPCs, wherein the way activation signal includes either a power relay signal or a power mask signal. Each of the plurality of WPCs is configured to receive a power management signal, relay the power management signal to the respective way in response to a determination that the way activation signal is a power relay signal, and mask the power management signal to the respective way in response to a determination that the way activation signal is a power mask signal.

### INTRODUCTION

Aspects of this disclosure relate generally to cache memory control, and more particularly to power control in a set-associative cache memory.

Power consumption characteristics for electronic devices (such as days-of-usage (DoU)) have improved, but limiting power consumption remains an important design consideration. Many devices include a processing system and one or more memory caches (for example, random access memory (RAM), cache L1, cache L2, cache L3, etc.). These caches contain data that is readily accessed, often multiple times, by the CPU system. Typically, the L1 cache has the smallest amount of storage. As a result, L1 cache can be accessed in the smallest amount of time. The L2 cache and the L3 cache may have progressively greater capacity, but greater capacity typically increases the amount of time it takes to retrieve the cached data.

In some implementations, each of the L1 cache, the L2 cache, and the L3 cache are powered up during processing. Because the L3 cache is the largest, it takes longest to power up. Accordingly, in an effort to power up each cache at the same time, the larger caches are given correspondingly bigger head starts. Once each of the caches is powered up, the processing system first attempts to access the L1 cache, then proceeds to the L2 cache if L1 cache capacity is full, and then proceeds to the L3 cache if L3 cache capacity is full.

In some other implementations, power collapsible banks (PCBs) are used to conserve resources by progressively powering up physical memory banks on an individual basis. In particular, a power management control circuit (PMCC) (which is external to the cache controller) uses software to control when each bank gets powered up. When the PMCC determines that it is necessary to power up another physical memory bank, the PMCC may modify a power management signal that is supplied to the physical memory bank. For example, the power management signal may instruct and/or enable the physical memory bank to wake up (and/or shut down). As a result, a system utilizing PCBs conserves some resources. However, the clock cycle used by the power management controller may be hundreds of times slower than the clock cycle used by the cache controller, so any changes made by the PMCC may be slow to take effect.

As will be discussed in greater detail below, the present disclosure reduces resource consumption using novel power-control techniques.

### SUMMARY

The following summary is an overview provided solely to aid in the description of various aspects of the disclosure and is provided solely for illustration of the aspects and not limitation thereof.

In accordance with aspects of the disclosure, a system is disclosed. The system comprises a set-associative memory cache comprising a plurality of ways, a plurality of way power controllers (WPCs), each WPC being respectively associated with a respective way of the plurality of ways, and a cache controller configured to provide a way activation signal to each of the plurality of WPCs. The way activation signal includes either a power relay signal or a power mask signal. Each of the plurality of WPCs is configured to receive the way activation signal provided by the cache controller, receive a power management signal, determine whether the way activation signal is the power relay signal or the power mask signal, relay the power management signal to the respective way in response to a determination that the way activation signal is a power relay signal, and mask the power management signal to the respective way in response to a determination that the way activation signal is a power mask signal.

In accordance with other aspects of the disclosure, a method is disclosed. The method comprises providing, from a cache controller and to each of a plurality of WPCs, a way activation signal. The way activation signal includes either a power relay signal or a power mask signal. Moreover, each WPC is respectively associated with a respective way of a plurality of ways in a set-associative memory cache. The method further comprises receiving, at each of the plurality of WPCs, the way activation signal provided by the cache controller, receiving, at each of the plurality of WPCs, a power management signal, determining, at each of the plurality of WPCs, whether the way activation signal is the power relay signal or the power mask signal, relaying the power management signal to the respective way in response to a determination that the way activation signal is a power relay signal, and masking the power management signal to the respective way in response to a determination that the way activation signal is a power mask signal.

In accordance with other aspects of the disclosure, an apparatus is disclosed. The apparatus comprises a memory cache comprising a plurality of means for storing, means for providing a way activation signal, wherein the way activation signal includes either a power relay signal or a power mask signal, and a plurality of means for receiving the way activation signal, wherein each means for receiving the way activation signal is respectively associated with a respective means for storing. The plurality of means for storing may each comprise means for receiving a power management signal, means for determining whether the way activation signal is the power relay signal or the power mask signal, means for relaying the power management signal to the respective way in response to a determination that the way activation signal is a power relay signal, and means for masking the power management signal to the respective way in response to a determination that the way activation signal is a power mask signal.

### BRIEF DESCRIPTION OF THE DRAWINGS

The accompanying drawings are presented to aid in the description of various aspects of the disclosure and are provided solely for illustration of the aspects and not limitation thereof.

FIG. 1 generally illustrates a timing chart associated with a conventional power control scheme.

FIG. 2 generally illustrates a timing chart associated with a power control scheme of the present disclosure.

FIG. 3 generally illustrates a timing chart associated with another power control scheme of the present disclosure.

FIG. 4 generally illustrates a system configured to perform the power control scheme of the present disclosure.

FIG. 5 generally illustrates a method for performing the power control scheme of the present disclosure.

FIG. 6 generally illustrates a system that is an example implementation of the system depicted in FIG. 4.

FIG. 7 generally illustrates a method that is an example implementation of the method depicted in FIG. 5.

FIG. 8 generally illustrates an example of a timing chart for allocating a data entry in a newly-powered way.

FIG. 9 generally illustrates an example of a timing chart for allocating a data entry in an already-powered way.

FIG. 10 generally illustrates an exemplary electronic device in which an aspect of the disclosure may be advantageously employed.

### DETAILED DESCRIPTION

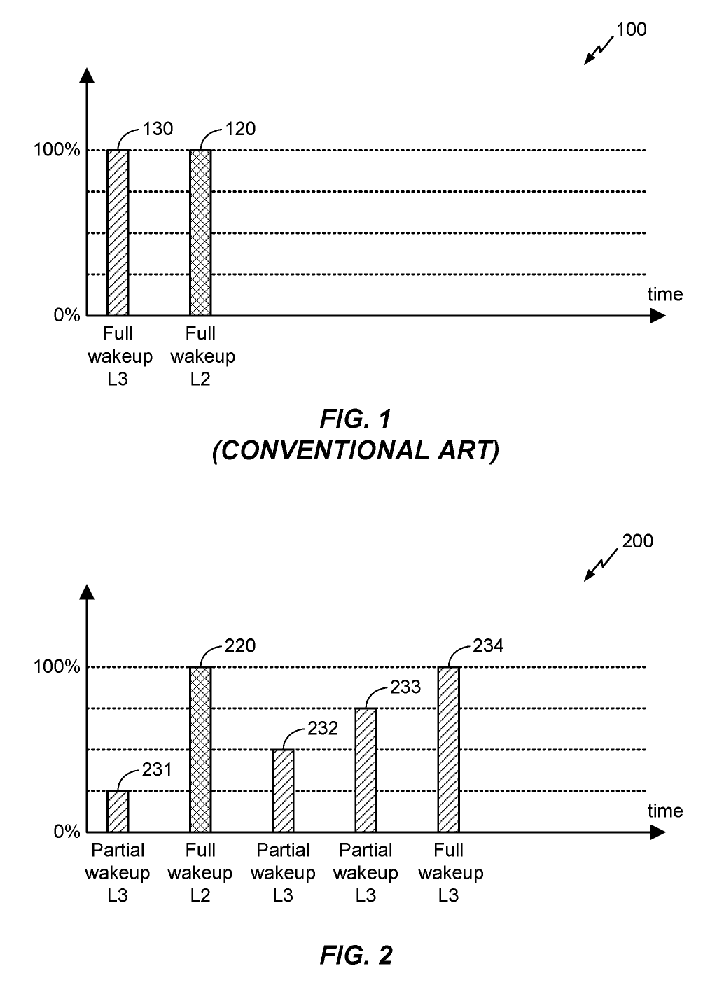

FIG. 1 generally illustrates a timing chart 100 associated with a conventional power control scheme.

As noted above, when a system commences to process data or instructions, the system will wake up the cache or caches. In the example of FIG. 1, there are two caches L2 and L3, with L2 being the smallest (and fastest) and L3 being the largest (and slowest). In an effort to power up each cache at the same time, the larger caches are given correspondingly bigger head starts. As can be observed from FIG. 1, L3 full wakeup 130 commences at a first time, and L2 full wakeup 120 commences at a second time. It will be understood that this is a resource-intensive approach. In particular, not all processing instances require full wakeup of all three caches.

FIG. 2 generally illustrates a timing chart 200 associated with a power control scheme of the present disclosure.

As will be understood from FIG. 2, the L3 cache exhibits progressive partial wakeup. Similar to the timing chart 100, the L3 cache commences wakeup first, followed at a later time by the L2 cache. Accordingly, L3 partial wakeup 231 occurs at a first time and L2 full wakeup 220 occurs at a second time later than the first time.

However, unlike FIG. 1, which depicts the L3 full wakeup 130, FIG. 2 depicts the L3 partial wakeup 231. In particular, only twenty-five percent of the L3 cache is awakened in accordance with the L3 partial wakeup 231. Later, and only if determined to be necessary, L3 partial wakeup 232 occurs, wherein fifty percent of the L3 cache is awakened. Later still, and only if determined to be necessary, a L3 partial wakeup 233 and a L3 full wakeup 234 occur, wherein seventy-five and one-hundred percent of the L3 cache, respectively, are awakened. By performing the L3 full wakeup 234 only when necessary, the progressive power-up scheme of the present disclosure reduces the resource consumption associated with usage of cache memory.

In some implementations, the L2 and/or L3 cache depicted in FIG. 2 may be a set-associative memory cache. Moreover, in accordance with the example of FIG. 2, the L3 cache may include four ways. By powering up the four ways individually, the power-up scheme of the present disclosure can achieve the L3 partial wakeup 231, L3 partial wakeup 232, L3 partial wakeup 233, and L3 full wakeup 234 depicted in FIG. 2. Although only the L3 cache exhibits progressive power-up in FIG. 2, it will be understood that the same technique may be applied to the L2 cache, an L1 cache, or to any other memory cache.

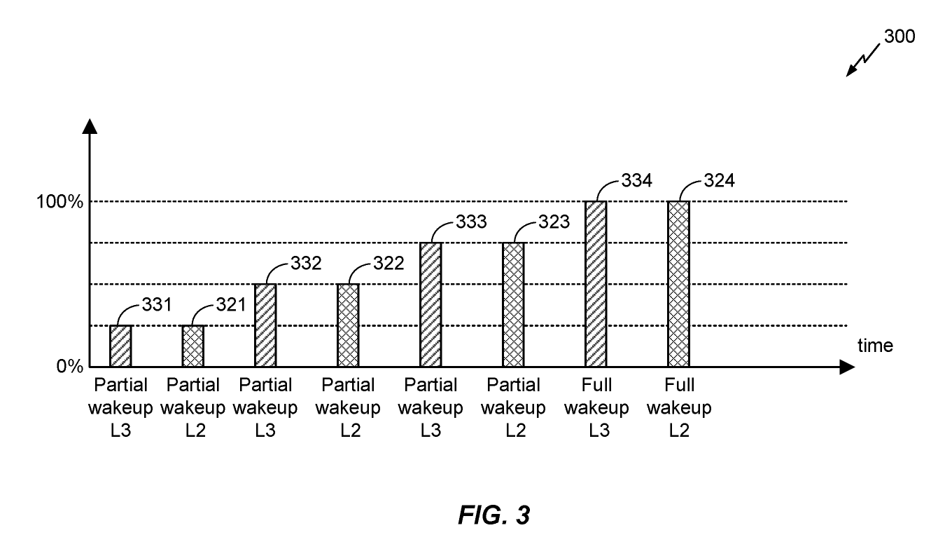

FIG. 3 generally illustrates a timing chart 300 associated with another power control scheme of the present disclosure.

As noted above, progressive power-up may be advantageously applied to any or all of the memory caches. In the example of FIG. 3, both the L2 and the L3 caches adopt the progressive power-up scheme of the present disclosure. Similar to the timing charts 100 and 200, the L3 cache commences wakeup first, followed at a later time by the L2 cache. Accordingly, L3 partial wakeup 331 occurs at a first time and L2 partial wakeup 321 occurs at a second time later than the first time.

In FIG. 3, as in FIG. 2, the L3 memory cache adopts the progressive power-up scheme. In particular, L3 partial wakeup 331 is performed such that twenty-five percent of the L3 cache is awakened, then L3 partial wakeup 332 is performed, later and only if necessary, such that fifty percent of the L3 cache is awakened, L3 partial wakeup 333 is performed, later and only if necessary, such that seventy-five percent of the L3 cache is awakened, and L3 full wakeup 334 is performed, later and only if necessary, such that one-hundred percent of the L3 cache is awakened.

Unlike the timing chart 200, in which the L3 cache is progressively powered up and the L2 is fully powered up, the timing chart 300 of FIG. 3 depicts progressive power-up of both the L2 cache and the L3 cache. In particular, L2 partial wakeup 321 is performed such that twenty-five percent of the L2 cache is awakened, then L2 partial wakeup 322 is performed, later and only if necessary, such that fifty percent of the L2 cache is awakened, L2 partial wakeup 323 is performed, later and only if necessary, such that seventy-five percent of the L2 cache is awakened, and L2 full wakeup 324 is performed, later and only if necessary, such that one-hundred percent of the L2 cache is awakened.

In the examples of FIG. 2 and FIG. 3, the L2 and/or L3 cache may include four ways that are awakened independently, as necessitated by processing application. However, it will be understood that the progressive wake-up scheme of the present disclosure is not limited to quartile adjustments. For example, the progressive wake-up scheme of the present disclosure may make coarser adjustments (for example, in a cache with only two ways) or finer adjustments (for example, in a cache with eight ways, sixteen ways, thirty-two ways, etc.).

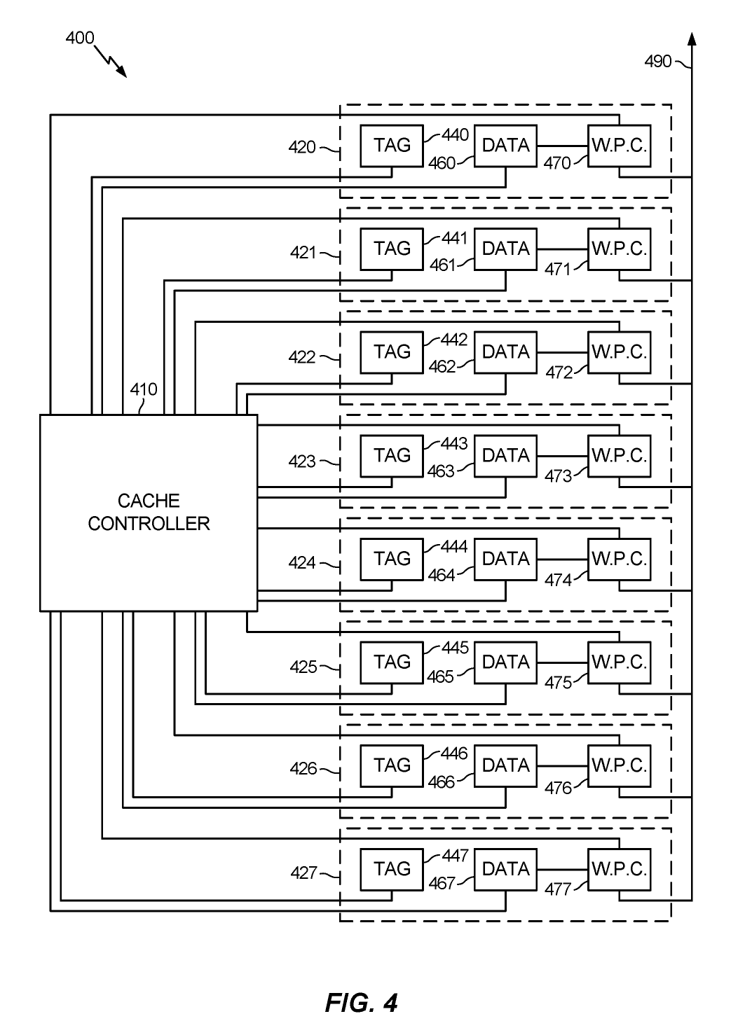

FIG. 4 generally illustrates a system 400 configured to perform the power control scheme of the present disclosure.

The system 400 may include a cache controller 410 and a set-associative memory cache comprising a plurality of ways. In the example depicted in FIG. 4, the set-associative memory cache includes eight ways 420-427. The ways may be identified by number. For example, way 420 may be referred to as “way 0”, way 421 may be referred to as “way 1”, etc.

Each way may include a tag RAM, a data RAM, and a way power controller (WPC). In particular, the way 420 may include a tag RAM 440, a data RAM 460, and a WPC 470, the way 421 may include a tag RAM 441, a data RAM 461, and a WPC 471, way 422 may include a tag RAM 442, a data RAM 462, and a WPC 472, way 423 may include a tag RAM 443, a data RAM 463, and a WPC 473, way 424 may include a tag RAM 444, a data RAM 464, and a WPC 474, way 425 may include a tag RAM 445, a data RAM 465, and a WPC 475, way 426 may include a tag RAM 446, a data RAM 466, and a WPC 476, and way 427 may include a tag RAM 447, a data RAM 467, and a WPC 477. As will be understood from FIG. 4, each of the plurality of WPCs 470-477 may be respectively associated with a particular way of the plurality of ways 420-427.

The cache controller 410 may be configured to provide a way activation signal to each of the plurality of WPCs 470-477. The way activation signal may include either a power relay signal or a power mask signal. Each of the plurality of WPCs 470-477 may be configured to receive the way activation signal provided by the cache controller 410. Each of the plurality of WPCs 470-477 may also be configured to receive a power management signal provided on a power management signal line 490. The power management signal may be received from a PMCC and provided to each of the plurality of WPCs 470-477, respectively, as shown in FIG. 4. The PMCC (not shown in FIG. 4), may be external with respect to the cache controller 410 and the plurality of WPCs 470-477. The PMCC may operate on a slower clock cycle than the cache controller 410 and the plurality of WPCS 470-477. For example, the PMCC may operate in accordance with a first clock cycle whereas the cache controller 410 and the plurality of WPCs 470-477 may operate in accordance with a second clock cycle that has a higher frequency than the first clock cycle.

Each of the plurality of WPCs 470-477 may further be configured to determine whether the way activation signal is the power relay signal or the power mask signal. If a particular WPC of the plurality of WPCs 470-477 determines that it has received the power relay signal from the cache controller 410, the particular WPC may relay the power management signal provided by the power management signal line 490 to the respective way. Alternatively, if the particular WPC determines that it has received the power mask signal from the cache controller 410, the particular WPC may mask the power management signal to the respective way.

As an example, suppose that the cache controller 410 intends to perform a partial wakeup of the set-associative memory cache depicted in FIG. 4, in particular, to twenty-five percent awake. To arrive at twenty-five percent wakeup, the cache controller 410 may activate the two ways with the highest priority from among the eight ways 420-427.

For example, the way 420 may be the highest-priority way and the way 421 may have the second-highest priority. Accordingly, the cache controller 410 may group the way 420 and the way 421 in a high-priority grouping of high-priority ways. The remaining ways 422-427 may be included in a low-priority grouping of low-priority ways, wherein each high-priority way associated with the high-priority grouping has a higher priority than each low-priority way associated with the low-priority grouping.

The cache controller 410 may control which ways are powered up by selecting the form of the way activation signal. In particular, the cache controller 410 may provide the way activation signal as the power relay signal to power up the ways in the high-priority grouping and may further provide the way activation signal as the power mask signal to keep the ways in the low-priority grouping powered down. Returning to the earlier example, the cache controller 410 may perform a twenty-five percent wakeup by providing the power relay signal to the WPC 470 and the WPC 471, and providing the power mask signal to the WPCs 472-477.

It will be further understood that the cache controller 410 may, under some circumstances, determine that additional cache is needed and that a deactivated way should be selectively awakened. For example, the cache controller 410 may determine that each way associated with the high-priority grouping (which includes the way 420 and the way 421 in this example) is exhausted. In response to this determination, the cache controller 410 may select a highest-priority way from among the low-priority grouping of ways 422-427 (for example, the way 422). The cache controller 410 may remove the selected way from the low-priority grouping and add the selected way to the high-priority grouping. As a result, the high-priority grouping may be modified such that it includes the ways 420-422 and the low-priority grouping may be modified such that it includes the ways 423-427.

As noted above, the PMCC that provides the power management signal may operate in accordance with a slower clock cycle than the cache controller 410 and the WPCs 470-477. Accordingly, any attempt to individually control the plurality of ways 420-427 via the power management signal line 490 will be slow, and the resources conserved will be limited. In accordance with the present disclosure, the PMCC may simply supply a power management signal sufficient to activate each of the plurality of ways 420-427, and the WPCs 470-477 may, under the direction of the cache controller 410, quickly toggle between relaying the power management signal (in response to a power relay signal from the cache controller 410) and masking the power management signal to low-priority ways (in response to a power mask signal from the cache controller 410). Because the cache controller 410 controls which ways get activated, each way can be activated as needed and when needed, regardless of how quickly the PMCC is configured to operate.

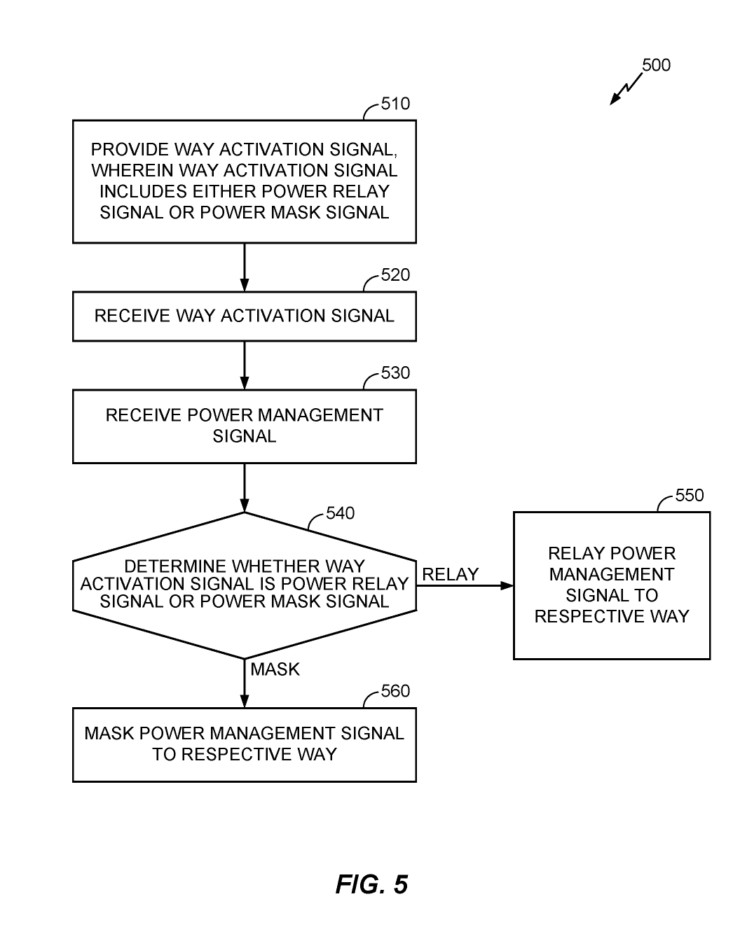

FIG. 5 generally illustrates a method 500 for performing the power control scheme of the present disclosure. The method 500 may be performed by, for example, the system 400 depicted in FIG. 4. The method 500 will be described below as it would be performed by the system 400 and/or various components thereof. However, it will be understood that the method 500 may be performed by any suitable system.

At 510, the method 500 may provide a way activation signal, wherein the way activation signal includes either a power relay signal or a power mask signal. The providing at 510 may be performed by, for example, the cache controller 410 depicted in FIG. 4. Accordingly, the cache controller 410 may constitute means for providing a way activation signal, wherein the way activation signal includes either a power relay signal or a power mask signal.

At 520, the method 500 may receive the way activation signal. The receiving at 520 may be performed by, for example, any or all of the plurality of WPCs 470-477 depicted in FIG. 4. Accordingly, the plurality of WPCs 470-477 may constitute a plurality of means for receiving the way activation signal.

At 530, the method 500 may receive a power management signal. The received power management signal may be analogous to the power management signal provided using the power management signal line 490 depicted in FIG. 4. The receiving at 530 may be performed by, for example, any or all of the plurality of WPCs 470-477 depicted in FIG. 4. Accordingly, each of the plurality of WPCs 470-477 may include means for receiving a power management signal.

At 540, the method 500 determines whether the way activation signal is a power relay signal or a power mask signal. If the method 500 determines that the way activation signal is a power relay signal (‘relay’ at 540), then the method 500 proceeds to 550. If the method 500 determines that the way activation signal is a power mask signal (‘mask’ at 540), then the method 500 proceeds to 560. The determining at 540 may be performed by, for example, any or all of the plurality of WPCs 470-477 depicted in FIG. 4. Accordingly, each of the plurality of WPCs 470-477 may include means for determining whether the way activation signal is the power relay signal or the power mask signal.

At 550, the method 500 relays the power management signal to the respective way. The relaying at 550 may be performed by, for example, any or all of the plurality of WPCs 470-477 depicted in FIG. 4. Accordingly, each of the plurality of WPCs 470-477 may include means for relaying the power management signal to the respective way in response to a determination that the way activation signal is a power relay signal.

At 560, the method 500 masks the power management signal to the respective way. The masking at 560 may be performed by, for example, any or all of the plurality of WPCs 470-477 depicted in FIG. 4. Accordingly, each of the plurality of WPCs 470-477 may include means for masking the power management signal to the respective way in response to a determination that the way activation signal is a power mask signal.

The functionalities depicted in FIG. 5 may be implemented in various ways consistent with the teachings herein. In some designs, the functionality may be implemented as one or more electrical components. In some designs, the functionality may be implemented as a processing system including one or more processor components. In some designs, the functionality may be implemented using, for example, at least a portion of one or more integrated circuits (e.g., an ASIC). As discussed herein, an integrated circuit may include a processor, software, other related components, or any combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the functionalities depicted in FIG. 5, as well as other components and functions described herein, may be implemented using any suitable means. Such means also may be implemented, at least in part, using corresponding structure as taught herein. The components described above may also correspond to similarly designated “code for” functionality. Thus, in some aspects one or more of such means may be implemented using one or more of processor components, integrated circuits, or other suitable structure as taught herein.

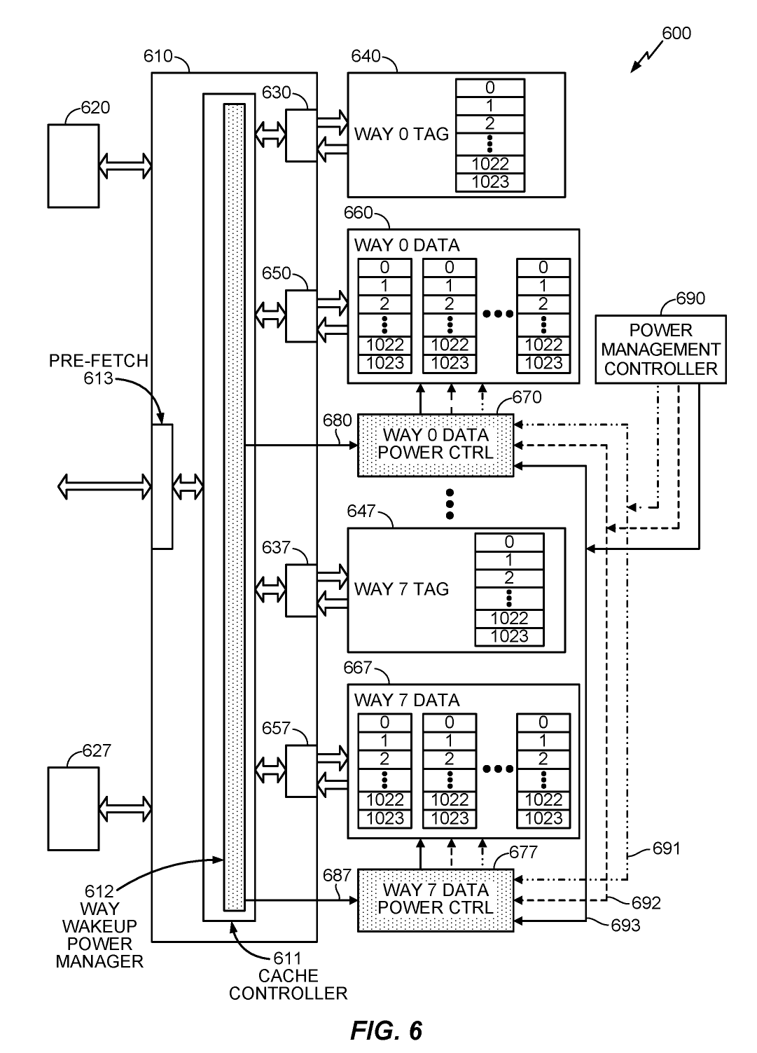

FIG. 6 generally illustrates a system 600 that is an example implementation of the system 400 depicted in FIG. 4.

The system 600 includes a cache controller apparatus 610. The cache controller apparatus 610 includes a cache controller 611 and a Way Wakeup Power Manager (WWPM) 612. The cache controller apparatus 610 may communicate with a processor 620 and/or a processor 627 via a CPU interface. The cache controller apparatus 610 may also communicate with a memory controller (not shown) via a pre-fetch interface 613. As will be discussed in greater detail below, the cache controller apparatus 610 may receive read/write (R/W) requests from the processor 620, the processor 627, and/or any other processors associated with the device. The R/W request may specify a memory address to be read or written.

The system 600 may include, for example, eight ways. However, in order to show the ways in detail, only two ways (way 0 and way 7) are depicted in FIG. 6. The cache controller apparatus 610 communicates with way 0 using a tag interface 630 for communicating with a tag RAM 640, a data interface 650 for communicating with a data RAM 660, and a data RAM control signal 680 for communicating with a WPC 670. The cache controller apparatus 610 communicates with way 7 using a tag interface 637 for communicating with a tag RAM 647, a data interface 657 for communicating with a data RAM 667, and a data RAM control signal 687 for communicating with a WPC 677.

In the example of FIG. 6, the tag RAM 640 and tag RAM 647 each include a bank with one thousand and twenty-four indices and eight bytes. The data RAM 660 and data RAM 667 each include eight banks with one thousand and twenty-four indices and eight bytes. Accordingly, the data RAM 660 and the data RAM 667 may each include sixty-four kilobytes.

Also depicted in FIG. 6 is a power management controller 690 which may be external to the system 600. The power management controller 690 may provide a memory periphery collapse signal 691, a memory bit-cell collapse signal 692, and a memory wakeup clock signal 693 to the system 600. As will be understood from FIG. 6, these signals may be provided directly to each of the WPCs, respectively. In some implementations, the signals provided to each of the respective WPCs are at all times identical.

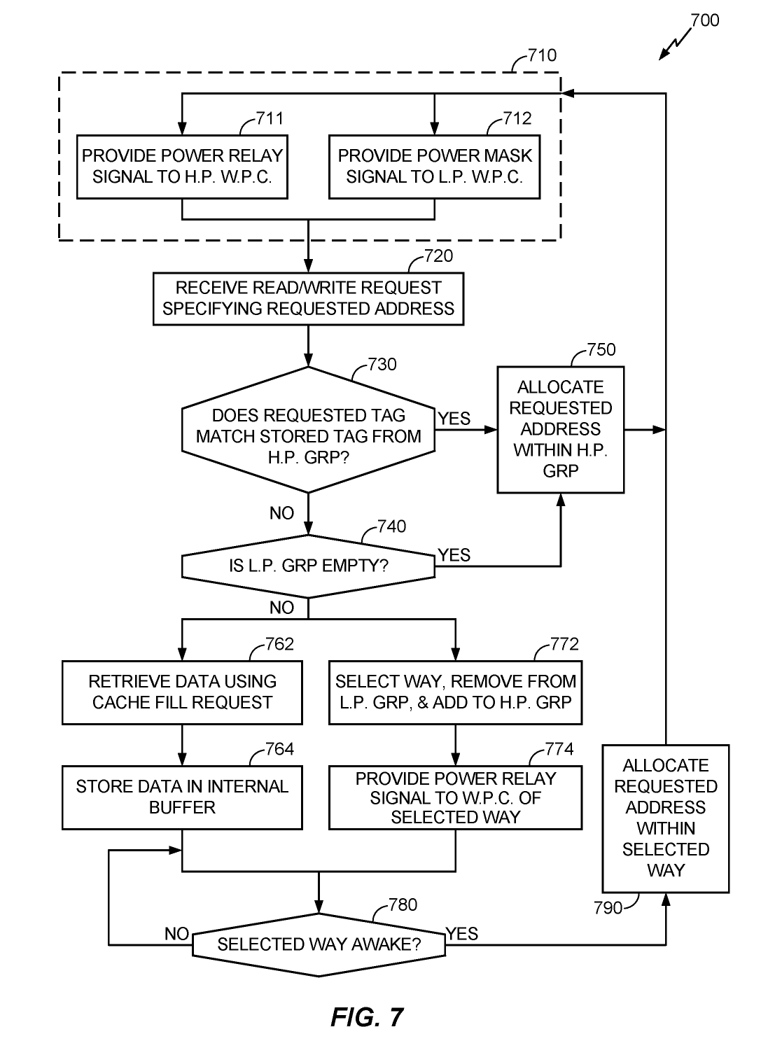

FIG. 7 generally illustrates a method 700 that is an example implementation of the method 500 depicted in FIG. 5. The method 700 may be performed by, for example, the system 400 depicted in FIG. 4 and/or the system 600 depicted in FIG. 6. The method 700 will be described below as it would be performed by the system 400 and/or various components thereof. However, it will be understood that the method 700 may be performed by any suitable system.

At 710, the cache controller 410 enters an idle mode. At 711, the cache controller 410 provides a power relay signal to high-priority WPCs (to return to an earlier example, the way 420 and the way 421). At 712, the cache controller 410 provides a power mask signal to low-priority WPCs (to return to the earlier example, the ways 422-427). When in the idle mode, the cache controller 410 may continuously provide the power relay signal and the power mask signal to the high-priority WPCs and low-priority WPCs, respectively.

In a scenario where a power collapse boot-up is being performed, the high-priority grouping may initially include a single way consisting of the highest-priority way, and the remaining ways may be included in the low-priority grouping.

At 720, the cache controller 410 receives a read or write request specifying a requested memory address. The requested memory address may include, for example, a tag field, an index field, and a byte selection field.

At 730, the cache controller 410 determines if the requested tag matches a stored tag from any way in the high-priority grouping. If the requested tag matches (‘yes’ at 730), then the method 700 proceeds to 750. If the requested tag does not match (‘no’ at 730), then the method 700 proceeds to 740.

To return to an earlier example, suppose that the way 420 and the way 421 make up the high-priority grouping. In this case, the cache controller 410 may determine whether the tag RAM 440 and/or the tag RAM 441 includes therein a stored tag that matches the requested tag. If the tag RAM 440 and/or the tag RAM 441 includes a stored tag that matches the requested tag, then the method 700 may proceed to 750. Otherwise, the method 700 proceeds to 740. It will be understood that the ways in the low-priority grouping are deactivated in order to conserve resources, and will not be checked for a matching tag.

At 740, the cache controller 410 determines if the low-priority grouping is empty, if the low-priority grouping is empty (‘yes’ at 740), then the method 700 proceeds to 750. If the low-priority grouping includes one or more ways (‘no’ at 740), then the method 700 proceeds to 762 and 772.

At 750, the cache controller 410 allocates the requested address within a way from the high-priority grouping. If there is a matching tag, then the allocation may proceed by reading or writing a line of data associated with the matching tag. If the low-priority grouping is empty, then that allocation may proceed by overwriting an existing line in one of the high-priority ways.

In the present example, the low-priority grouping (which includes each of the ways 422-427) is not empty. Accordingly, the method 700 proceeds to 762 and 772.

At 762, the cache controller 410 retrieves data using a cache fill request. At 764, the cache controller 410 stores the retrieved data in an internal buffer. In some implementations, the cache fill request may be performed using an Application Control Engine (ACE) protocol. ACE may be an interconnect protocol for coupling processing systems to main memory (for example, Double Data Rate (DDR) main memory). Because in this example there are no matching tags in the tag RAM 440 or the tag RAM 441, the cache controller 410 will retrieve and store the data specified in the read/write request received at 720.

At 772, the cache controller 410 selects the highest-priority way from among the low-priority grouping, removes the selected way from the low-priority grouping, and adds the selected way to the high-priority grouping. At 774, the cache controller 410 provides a power relay signal to the WPC associated with the selected way. In the present example, the highest-priority way in the low-priority grouping is the way 422. Accordingly, the cache controller 410 may select the way 422 and provide the WPC 472 with a power relay signal.

At 780, the cache controller 410 determines if the selected way is awake. If the selected way is not awake (‘no’ at 780), then the method 700 returns to 780. If the selected way is awake (‘yes’ at 780), then the method 700 proceeds to 790. As noted above, in the present example, the way 422 is activated by providing a power relay signal to the WPC 472. Accordingly, the cache controller 410 waits for the way 422 to awaken before proceeding. In the meantime (i.e., during the time period before the way 422 is awakened), the requested data can be retrieved from the internal buffer at which the data is stored at 764.

At 790, the method 700 allocates the requested address within the selected way. The allocating at 790 may be performed by, for example, moving or copying the data from the internal buffer into the data RAM 462 of the newly-activated way. The cache controller 410 may also update the tag RAM 442 such that the tag associated with the data is registered.

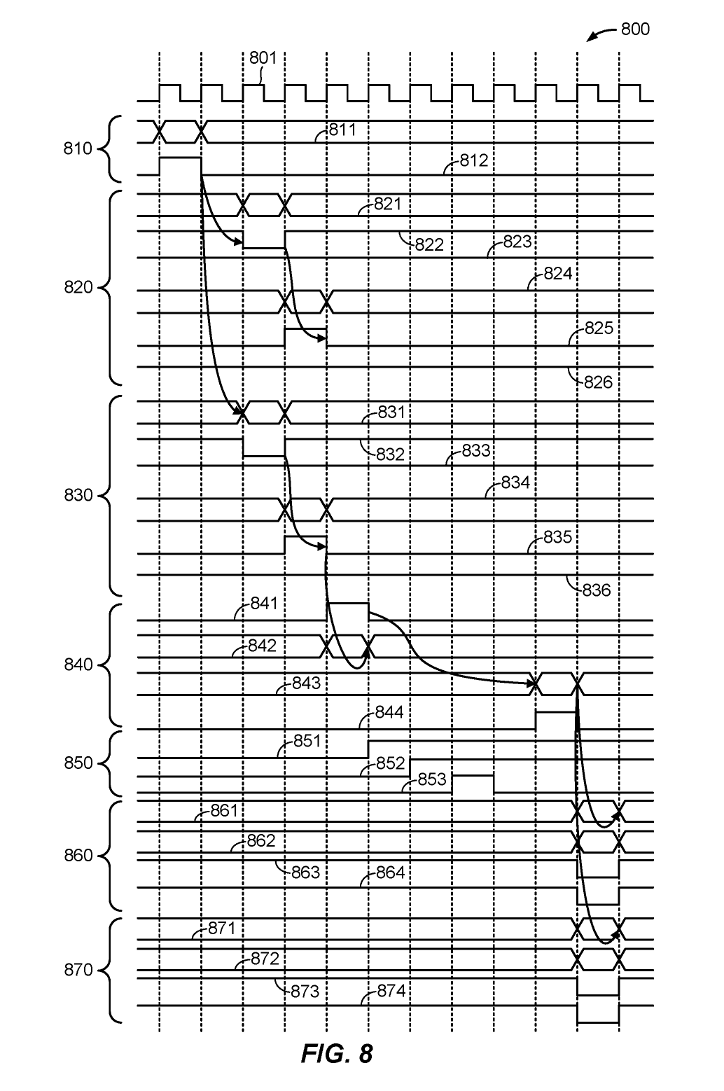

FIG. 8 generally illustrates an example of a timing chart 800 for allocating a data entry in a newly-powered way. In the timing chart 800, we return to a previous example in which (at least in an initial state) the two highest-priority ways (way 0 and way 1) are activated and the remaining ways (ways 2 . . . n) are deactivated. The timing chart 800 will be described as if the system 400 and/or various components thereof is performing the tasks depicted in FIG. 8. However, it will be understood that the system 600 depicted in FIG. 6 or any other suitable device of the present disclosure may be used to perform the tasks depicted in FIG. 8. Various portions of the timing chart 800 may correspond to various blocks in the method 500 depicted in FIG. 5 and/or the method 700 depicted in FIG. 7.

The timing chart 800 operates in accordance with a cache controller clock signal 801, which indicates the timing of each cycle of a cache controller clock. The timing chart 800 shows twelve full clock cycles, wherein each clock cycle begins on a rising edge of the cache controller clock signal 801.

The timing chart 800 depicts a CPU read/write (R/W) interface 810, a way-0 tag RAM control interface 820, a way-1 tag RAM control interface 830, an ACE channel 840, way-2 data RAM power control bits 850, a way-2 tag RAM interface 860, and a way-2 data RAM interface 870.

In the timing chart 800, a R/W request is received by the cache controller 410 during the first clock cycle. In particular, a R/W address signal 811 indicates a particular memory address (including a tag field and an index field) and a R/W validity signal 812 triggers a read and/or write associated with the data at the indicated memory address.

After receiving the R/W request, the cache controller 410 checks each way in the high-priority grouping for a tag that matches the requested tag in the R/W request. The checking is performed in an analogous manner via the way-0 tag RAM control interface 820 and the way-1 tag RAM control interface 830. The way-0 tag RAM control interface 820 and the way-1 tag RAM control interface 830 enable the cache controller 410 to communicate with the tag RAM 440 and tag RAM 441, respectively.

The way-0 tag RAM control interface 820 includes a way-0 tag RAM address signal 821 and a way-0 tag RAM chip select signal 822. As will be understood from FIG. 8, the requested address is received at the tag RAM 440 in the third clock cycle via the way-0 tag RAM address signal 821 and the way-0 tag RAM chip select signal 822.

A way-0 tag RAM write enable signal 823 is depicted, but it will be understood that throughout the example timing chart 800, writing to the tag RAM is disabled.

The tag RAM 440 may then check a set in the cache that corresponds to the requested set indicated in the index field of the requested memory address. At the requested set, the tag RAM 440 checks for a tag that matches the requested tag indicated in the tag field of the requested memory address. The checking is performed using a way-0 tag RAM read data signal 824 and a way-0 tag RAM data validity signal 825. The result of the check is indicated in a way-0 tag RAM address hit signal 826. In this example, the tag associated with the requested set (indicated by the way-0 tag RAM read data signal 824) does not match the requested tag. Moreover, the set entry is determined to be valid (as indicated by the way-0 tag RAM data validity signal 825). If there is a valid entry in the cache that does not have a matching tag, as in this example, it may be referred to as a “cache miss”. The cache miss is indicated using the way-0 tag RAM address hit signal 826, which remains in its initial state in response to the determination that there is a valid entry with a non-matching tag in the cache.

As will be understood from FIG. 8, way 1 is checked in parallel with (i.e., at the same time as) way 0. Although there are only two activated ways in the present example, it will be understood that any number of activated ways may be checked in parallel. By contrast, the deactivated ways (ways 2 . . . n in the present example) are not checked, thereby conserving resources.

The way-1 tag RAM control interface 830 includes a way-1 tag RAM address signal 831 and a way-1 tag RAM chip select signal 832. As will be understood from FIG. 8, the requested address is received at the tag RAM 441 in the third clock cycle via the way-1 tag RAM address signal 831 and the way-1 tag RAM chip select signal 832.

A way-1 tag RAM write enable signal 833 is depicted, but it will be understood that throughout the example timing chart 800, writing to the tag RAM is disabled.

The tag RAM 441 may then check a set in the cache that corresponds to the requested set indicated in the index field of the requested memory address. At the requested set, the tag RAM 441 checks for a tag that matches the requested tag indicated in the tag field of the requested memory address. The checking is performed using a way-1 tag RAM read data signal 834 and a way-1 tag RAM data validity signal 835. The result of the check is indicated in a way-1 tag RAM address hit signal 836. In this example, the tag associated with the requested set (indicated by the way-1 tag RAM read data signal 834) does not match the requested tag. Moreover, the set entry is determined to be valid (as indicated by the way-1 tag RAM data validity signal 835). If there is a valid entry in the cache that does not have a matching tag, as in this example, it may be referred to as a “cache miss”. The cache miss is indicated using the way-1 tag RAM address hit signal 836, which remains in its initial state in response to the determination that there is a valid entry with a non-matching tag in the cache.

Because the tag RAM 440 and the tag RAM 441 both indicate a cache miss, the cache controller 410 must fetch the requested data from the main memory. As will be understood from FIG. 8, the fetching may be requested (during the fifth clock cycle) immediately after the cache miss is reported (during the fourth clock cycle). To fetch the data at the requested address if the main memory, the cache controller 410 communicates with the main memory (for example, DDR) via the ACE channel 840. Over the ACE channel 840, the cache controller 410 uses a DDR read validity signal 841 and a DDR read address signal 842 to identify the data to be fetched.

Meanwhile, the cache controller 410 activates a new way from the low-priority grouping (assuming that a new way is available). Accordingly, the cache controller 410 selects the highest-priority way from the low-priority grouping and uses the way-2 data RAM power control bits 850 to wake up the selected way. In particular, a first way-2 data RAM power control bit 851 switches at the sixth cycle, a second way-2 data RAM power control bit 852 switches at the seventh cycle, and a third way-2 data RAM power control bit 853 switches at the beginning and end of the eighth cycle.

In the present example, the wakeup of way 2 is performed while the fetching is being performed. Accordingly, way 2 may be active once the fetching is completed. As will be understood from FIG. 8, the fetching is completed in the tenth clock cycle. The fetched data from Main Memory (for example, DDR) is indicated on a ACE read response data signal 843 and the validity of the data is indicated on a ACE read response validity signal 844.

If, at this time, way 2 is awake, then fetched data may be immediately written to an entry in way 2. In the present example, way 2 is indeed awake when the data is fetched. Because the cache controller 410 immediately began the activation process for the new way (way 2) in response to a cache miss from each of the active ways (ways 0 and 1), the newly-activated way is more likely to be awake when the data fetching is complete. In the event that the data fetch is complete before way 2 is activated (not shown in FIG. 8), the data can be stored in an internal buffer of the cache controller 410 and provided to the CPU that made the request.

In the eleventh cycle, the cache controller 410 updates the tag RAM 442 via the way-2 tag RAM interface 860 and writes the fetched data into a corresponding entry in the data RAM 462 via the way-2 data RAM interface 870. The tag RAM 442 is updated by writing the requested tag to the way 2 cache entry that corresponds to the requested index of the fetched data. The updating may be performed using a way-2 tag RAM address signal 861 and a way-2 tag RAM write data signal 862. The allocation of the way 2 cache entry is indicated using a first way-2 tag RAM allocation signal 863 and a second way-2 tag RAM allocation signal 864.

At the same time, the cache controller 410 uses a way-2 data RAM address signal 871 to update the data RAM 462 by writing the requested tag to the way 2 cache entry corresponding to the requested index of the fetched data. The fetched data itself may also be allocated to the way 2 cache entry using the way-2 data RAM write signal 872. The allocation of the way 2 cache entry is indicated using a first way-2 data RAM allocation signal 873 and a second way-2 data RAM allocation signal 874.

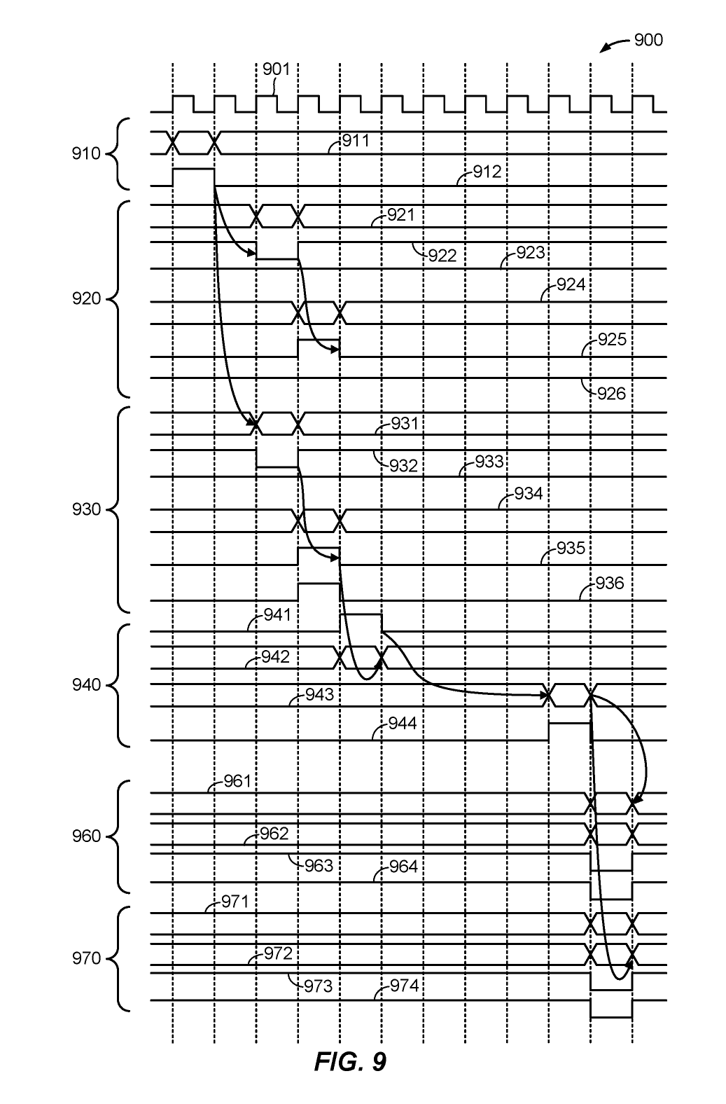

FIG. 9 generally illustrates an example of a timing chart 900 for allocating a data entry in a newly-powered way. The primary difference between the timing chart 900 and the timing chart 800 is that a matching tag is found on way 1 in FIG. 9, whereas no matching tag is found on way 1 in FIG. 8. Accordingly, it is not necessary to wake up way 2 in the scenario of FIG. 9.

In the timing chart 900, we return to the previous example in which (at least in an initial state) the two highest-priority ways (way 0 and way 1) are activated and the remaining ways (ways 2 . . . n) are deactivated. The timing chart 900 will be described as if the system 400 and/or various components thereof is performing the tasks depicted in FIG. 9. However, it will be understood that the system 600 depicted in FIG. 6 or any other suitable device of the present disclosure may be used to perform the tasks depicted in FIG. 9. Various portions of the timing chart 900 may correspond to various blocks in the method 500 depicted in FIG. 5 and/or the method 700 depicted in FIG. 7.

The timing chart 900 operates in accordance with a cache controller clock signal 901, which indicates the timing of each cycle of a cache controller clock. The timing chart 900 shows twelve full clock cycles, wherein each clock cycle begins on a rising edge of the cache controller clock signal 901.

The timing chart 900 depicts a CPU read/write (R/W) interface 910, a way-0 tag RAM control interface 920, a way-1 tag RAM control interface 930, an ACE channel 940, way-2 data RAM power control bits 950, a way-1 tag RAM interface 960, and a way-1 data RAM interface 970.

The CPU R/W interface 910 (which includes a R/W address signal 911 and a R/W validity signal 912) may be analogous to the CPU R/W interface 810 (and its component signals). For brevity, further description of the CPU R/W interface 910 will be omitted.

The way-0 tag RAM control interface 920 (which includes a way-0 tag RAM address signal 921, a way-0 tag RAM chip select signal 922, a way-0 tag RAM write enable signal 923, a way-0 tag RAM read data signal 924, a way-0 tag RAM data validity signal 925, and a way-0 tag RAM address hit signal 926) may be analogous to the way-0 tag RAM control interface 820 (and its component signals). For brevity, further description of the CPU R/W interface 920 will be omitted. It will be understood that the result of the communications on the CPU R/W interface 920 is that a cache miss is indicated for way 0.

The way-1 tag RAM control interface 930 (which includes a way-1 tag RAM address signal 931, a way-1 tag RAM chip select signal 932, a way-1 tag RAM write enable signal 933, a way-1 tag RAM read data signal 934, a way-1 tag RAM data validity signal 935, and a way-1 tag RAM address hit signal 936) may be analogous to the way-1 tag RAM control interface 830 (and its component signals). It will be understood from FIG. 9 that a valid entry with a matching tag has been located in way 1. If there is a valid entry in the cache that does has a matching tag, as in the example of FIG. 9, it may be referred to as a “cache hit”. The cache hit is indicated using the way-1 tag RAM address hit signal 936, which switches from its initial state during the fourth clock cycle in response to the determination that there is a valid entry with a matching tag in the cache.

After the tag RAM 441 indicates a cache hit, the cache controller 410 fetches the requested data from the main memory (for example, DDR) via ACE channel 940. As will be understood from FIG. 9, the fetching may be requested (during the fifth clock cycle) immediately after the cache hit is reported (during the fourth clock cycle). To fetch the data at the requested address if the main memory, the cache controller 410 communicates with the main memory (for example, DDR) via the ACE channel 940. Over the ACE channel 940, the cache controller 410 uses a ACE read validity signal 941 and a ACE read address signal 942 to identify the data to be fetched. The fetched data is indicated on a ACE read response data signal 943 and the validity of the data is indicated on a ACE read response validity signal 944.

The fetched data may then be written to the entry with the matching tag in way 1. In the eleventh cycle, the cache controller 410 updates the tag RAM 441 via the way-1 tag RAM interface 960 and writes the fetched data into a corresponding entry in the data RAM 461 via the way-1 data RAM interface 970. The tag RAM 441 is updated by writing the requested tag to the way 1 cache entry that corresponds to the requested index of the fetched data. The updating may be performed using a way-1 tag RAM address signal 961 and a way-1 tag RAM write data signal 962. The allocation of the way 2 cache entry is indicated using a first way-1 tag RAM allocation signal 963 and a second way-1 tag RAM allocation signal 964.

At the same time, the cache controller 410 uses a way-1 data RAM address signal 971 to update the data RAM 461 by writing the requested tag to the way 1 cache entry corresponding to the requested index of the fetched data. The fetched data itself may also be allocated to the way 1 cache entry using a way-1 data RAM write signal 972. The allocation of the way 1 cache entry is indicated using a first way-1 data RAM allocation signal 973 and a second way-1 data RAM allocation signal 974.

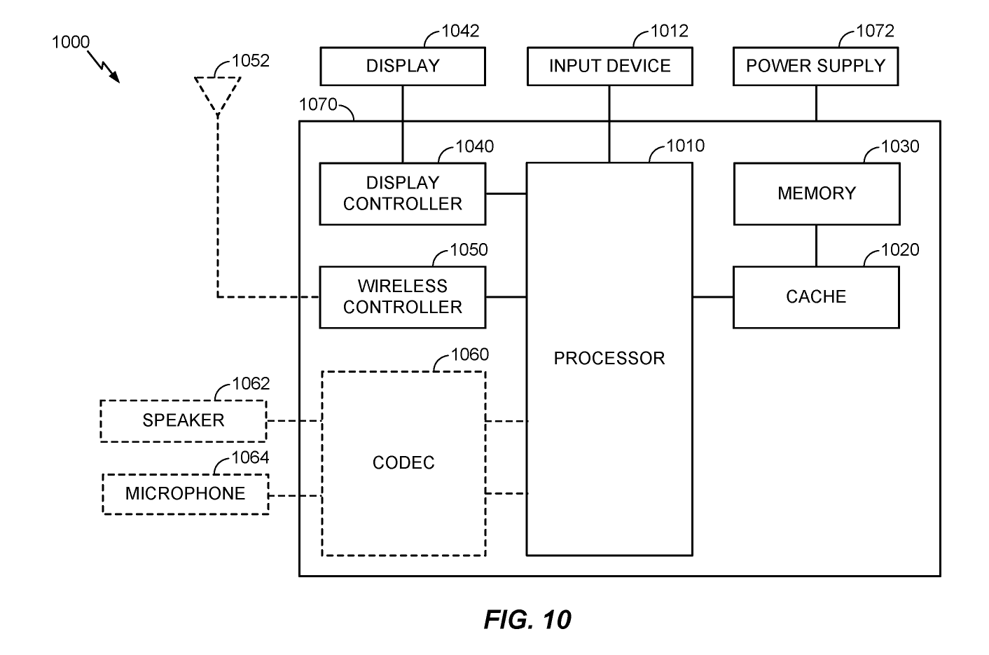

FIG. 10 generally illustrates an exemplary electronic device 1000 in which an aspect of the disclosure may be advantageously employed.

Electronic device 1000 may incorporate the system 400 depicted in FIG. 4, a system configured to perform the method 500 depicted in FIG. 5, the system 600 depicted in FIG. 6, and/or a system configured to perform the method 700 depicted in FIG. 7. In the depiction of FIG. 10, electronic device 1000 is shown to include a processor 1010. Electronic device 1000 may further comprise a cache 1020. In FIG. 10, processor 1010 is exemplarily shown to be coupled to memory 1030 with cache 1020 between processor 1010 and memory 1030, but it will be understood that other memory configurations known in the art may also be supported by electronic device 1000.

FIG. 10 also depicts a display controller 1040 that is coupled to processor 1010 and to display 1042. In some cases, electronic device 1000 may be used for wireless communication. FIG. 10 depicts optional blocks in dashed lines, such as coder/decoder (CODEC) 1060 (e.g., an audio and/or voice CODEC) coupled to processor 1010. A speaker 1062 and a microphone 1064 may also be coupled to CODEC 1060. Moreover, a wireless antenna 1052 may be coupled to a wireless controller 1050 which is coupled to processor 1010. Where one or more of these optional blocks are present, in a particular aspect, processor 1010, display controller 1040, memory 1030, and wireless controller 1050 are included in a system-in-package or system-on-chip device 1070.

Accordingly, a particular aspect, an input device 1012 and a power supply 1072 are coupled to the system-on-chip device 1070. Moreover, in a particular aspect, as illustrated in FIG. 10, where one or more optional blocks are present, display 1042, input device 1012, speaker 1062, microphone 1064, wireless antenna 1052, and power supply 1072 are external to the system-on-chip device 1070. However, each of display 1042, input device 1012, speaker 1062, microphone 1064, wireless antenna 1052, and power supply 1072 can be coupled to a component of the system-on-chip device 1070, such as an interface or a controller. In some implementations, one or more of the components of the electronic device 1000 may communicate with one another via a system bus.

It should be noted that although FIG. 10 generally depicts a generic electronic device 1000, one or more of the components of the electronic device 1000 may additionally or alternatively be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for bus control. Accordingly, the invention is not limited to illustrated examples and any means for performing the functionality described herein are included in aspects of the invention.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of non-transitory storage medium known in the art. As used herein the term “non-transitory” does not exclude any physical storage medium or memory and particularly does not exclude dynamic memory (e.g., RAM) but rather excludes only the interpretation that the medium can be construed as a transitory propagating signal. An example storage medium is coupled to the processor such that the processor can read information from, and write information to, the storage medium. In the alternative, the storage medium may be integral to the processor (e.g., cache memory).

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the apparatus claims in accordance with the aspects of the disclosure described herein need not be performed in any particular order. Furthermore, although certain aspects may be described or claimed in the singular, the plural is contemplated unless limitation to the singular is explicitly stated.

It will be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not imply that there are only two elements and further does not imply that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements”.

The terminology used herein is for the purpose of describing particular embodiments only and not to limit any embodiments disclosed herein. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. Similarly, the phrase “based on” as used herein does not necessarily preclude influence of other factors and should be interpreted in all cases as “based at least in part on” rather than, for example, “based solely on”.

It will be understood that terms such as “top” and “bottom”, “left” and “right”, “vertical” and “horizontal”, etc., are relative terms used strictly in relation to one another, and do not express or imply any relation with respect to gravity, a manufacturing device used to manufacture the components described herein, or to some other device to which the components described herein are coupled, mounted, etc. The term “exchange” may refer to one or more data transfers from one component to another. For example, with respect to a particular component, exchanging functionality may be constituted by sending functionality, receiving functionality, or any combination thereof.

What is claimed is:

1. A system comprising:
a set-associative memory cache comprising a plurality of ways;
a plurality of way power controllers (WPCs), each WPC being respectively associated with a respective way of the plurality of ways; and
a cache controller configured to provide a way activation signal to each of the plurality of WPCs, wherein the way activation signal includes either a power relay signal or a power mask signal;
wherein each of the plurality of WPCs is configured to:
receive the way activation signal provided by the cache controller;
receive a power management signal;
determine whether the way activation signal is the power relay signal or the power mask signal;
relay the power management signal to the respective way in response to a determination that the way activation signal is a power relay signal; and
mask the power management signal to the respective way in response to a determination that the way activation signal is a power mask signal.

2. The system of claim 1, wherein the power management signal is received from a power management control circuit and provided to each of the plurality of WPCs, respectively.

3. The system of claim 2, wherein:
the power management control circuit is external with respect to the cache controller and the plurality of WPCs and operates in accordance with a first clock cycle; and
the cache controller and the plurality of WPCs operate in accordance with a second clock cycle that has a higher frequency than the first clock cycle.

4. The system of claim 1, wherein the plurality of ways comprises a high-priority grouping of high-priority ways and a low-priority grouping of low-priority ways, wherein each high-priority way associated with the high-priority grouping has a higher priority than each low-priority way associated with the low-priority grouping.

5. The system of claim 4, wherein the cache controller is further configured to:
provide the power relay signal to each WPC that is associated with the high-priority grouping; and
provide the power mask signal to each WPC that is associated with the low-priority grouping.

6. The system of claim 5, wherein the cache controller is further configured to:
determine that each way associated with the high-priority grouping is exhausted;
select a highest-priority way from among the low-priority grouping;
remove the selected way from the low-priority grouping; and
add the selected way to the high-priority grouping.

7. The system of claim 6, wherein the cache controller is further configured to, in response to the selection, removal, and addition of the selected way:
provide a second power relay signal to each WPC that is associated with the high-priority grouping; and
provide a second power block instruction to each WPC that is associated with the low-priority grouping.

8. The system of claim 6, wherein to determine that each way associated with the high-priority grouping is exhausted, the cache controller is further configured to:
receive a read/write request having a requested memory address, wherein the memory address includes a requested index and a requested tag;
identify a set of one or more cache lines associated with the requested index, wherein each cache line in the set of one or more cache lines is associated with a different way from the high-priority grouping;
determine whether at least one cache line in the identified set of cache lines includes a stored tag that matches the requested tag; and
in response to a determination that no cache line in the identified set of cache lines includes the stored tag that matches the requested tag, determining that the high-priority grouping is exhausted.

9. The system of claim 8, wherein the cache controller is further configured to:
in response to a determination that at least one cache line in the identified set of cache lines includes the stored tag that matches the requested tag, determining that the high-priority grouping is not exhausted.

10. The system of claim 1, wherein the system is provided in a device selected from a group consisting of a set top box, a music player, a video player, an entertainment unit, a navigation device, a personal digital assistant (PDA), a fixed location data unit, a computer, a laptop, a tablet, a communications device, and a mobile phone.

11. A method, comprising:
providing, from a cache controller and to each of a plurality of way power controllers (WPCs), a way activation signal, wherein the way activation signal includes either a power relay signal or a power mask signal, and each WPC is respectively associated with a respective way of a plurality of ways in a set-associative memory cache;
receiving, at each of the plurality of WPCs, the way activation signal provided by the cache controller;
receiving, at each of the plurality of WPCs, a power management signal;
determining, at each of the plurality of WPCs, whether the way activation signal is the power relay signal or the power mask signal;
relaying the power management signal to the respective way in response to a determination that the way activation signal is a power relay signal; and
masking the power management signal to the respective way in response to a determination that the way activation signal is a power mask signal.

12. The method of claim 11, wherein the power management signal is received from a power management control circuit and provided to each of the plurality of WPCs, respectively.

13. The method of claim 12, wherein:
the power management control circuit is external with respect to the cache controller and the plurality of WPCs and operates in accordance with a first clock cycle; and
the cache controller and the plurality of WPCs operate in accordance with a second clock cycle that has a higher frequency than the first clock cycle.

14. The method of claim 11, wherein the plurality of ways comprises a high-priority grouping of high-priority ways and a low-priority grouping of low-priority ways, wherein each high-priority way associated with the high-priority grouping has a higher priority than each low-priority way associated with the low-priority grouping.

15. The method of claim 14, further comprising:
providing the power relay signal to each WPC that is associated with the high-priority grouping; and
providing the power mask signal to each WPC that is associated with the low-priority grouping.

16. The method of claim 15, further comprising:
determining that each way associated with the high-priority grouping is exhausted;
selecting a highest-priority way from among the low-priority grouping;
removing the selected way from the low-priority grouping; and
adding the selected way to the high-priority grouping.

17. The method of claim 16, further comprising, in response to the selection, removal, and addition of the selected way:
providing a second power relay signal to each WPC that is associated with the high-priority grouping; and
providing a second power block instruction to each WPC that is associated with the low-priority grouping.

18. The method of claim 16, wherein determining that each way associated with the high-priority grouping is exhausted comprises:
receiving a read/write request having a requested memory address, wherein the memory address includes a requested index and a requested tag;
identifying a set of one or more cache lines associated with the requested index, wherein each cache line in the set of one or more cache lines is associated with a different way from the high-priority grouping;
determining whether at least one cache line in the identified set of cache lines includes a stored tag that matches the requested tag; and
determining that the high-priority grouping is exhausted in response to a determination that no cache line in the identified set of cache lines includes the stored tag that matches the requested tag.

19. The method of claim 18, further comprising:
determining that the high-priority grouping is not exhausted in response to a determination that at least one cache line in the identified set of cache lines includes the stored tag that matches the requested tag.

20. The method of claim 11, wherein the method is implemented in a device selected from a group consisting of a set top box, a music player, a video player, an entertainment unit, a navigation device, a personal digital assistant (PDA), a fixed location data unit, a computer, a laptop, a tablet, a communications device, and a mobile phone.

21. An apparatus, comprising:
a memory cache comprising a plurality of means for storing;
means for providing a way activation signal, wherein the way activation signal includes either a power relay signal or a power mask signal;
a plurality of means for receiving the way activation signal, wherein each means for receiving the way activation signal is respectively associated with a respective means for storing of the plurality of means for storing and further comprises:
means for receiving a power management signal;
means for determining whether the way activation signal is the power relay signal or the power mask signal;
means for relaying the power management signal to the respective way in response to a determination that the way activation signal is a power relay signal; and
means for masking the power management signal to the respective way in response to a determination that the way activation signal is a power mask signal.

22. The apparatus of claim 21, wherein the power management signal is received from means for power management and provided to each of the means for storing, respectively.

23. The apparatus of claim 22, wherein:
the means for power management is external with respect to the means for providing a way activation signal and the means for receiving the way activation signal and operates in accordance with a first clock cycle; and
the means for providing a way activation signal and the means for receiving the way activation signal operate in accordance with a second clock cycle that has a higher frequency than the first clock cycle.

24. The apparatus of claim 21, wherein the plurality of means for storing comprises a high-priority grouping of high-priority means for storing and a low-priority grouping of low-priority means for storing, wherein each high-priority means for storing associated with the high-priority grouping has a higher priority than each low-priority means for storing associated with the low-priority grouping.

25. The apparatus of claim 24, further comprising:
means for providing the power relay signal to each means for receiving the way activation signal that is associated with the high-priority grouping; and
means for providing the power mask signal to each means for receiving the way activation signal that is associated with the low-priority grouping.

26. The apparatus of claim 25, further comprising:
means for determining that each means for storing associated with the high-priority grouping is exhausted;
means for selecting a highest-priority means for storing from among the low-priority grouping;
means for removing the selected means for storing from the low-priority grouping; and
means for adding the selected means for storing to the high-priority grouping.

27. The apparatus of claim 26, further comprising:
means for providing a second power relay signal to each WPC that is associated with the high-priority grouping in response to the selection, removal, and addition of the selected means for storing; and
means for providing a second power block instruction to each WPC that is associated with the low-priority grouping in response to the selection, removal, and addition of the selected means for storing.

28. The apparatus of claim 26, wherein the means for determining that each means for storing associated with the high-priority grouping is exhausted comprises:
means for receiving a read/write request having a requested memory address, wherein the memory address includes a requested index and a requested tag;
means for identifying a set of one or more cache lines associated with the requested index, wherein each cache line in the set of one or more cache lines is associated with a different means for storing from the high-priority grouping;
means for determining whether at least one cache line in the identified set of cache lines includes a stored tag that matches the requested tag; and
means for determining that the high-priority grouping is exhausted in response to a determination that no cache line in the identified set of cache lines includes the stored tag that matches the requested tag.

29. The apparatus of claim 28, further comprising:
means for determining that the high-priority grouping is not exhausted in response to a determination that at least one cache line in the identified set of cache lines includes the stored tag that matches the requested tag.

30. The apparatus of claim 21, wherein the apparatus is provided in a device selected from a group consisting of a set top box, a music player, a video player, an entertainment unit, a navigation device, a personal digital assistant (PDA), a fixed location data unit, a computer, a laptop, a tablet, a communications device, and a mobile phone.
